(19) United States
(12) Patent Application Publication
(10) Pub. No.: US 2003/0120486 A1
(43) Pub. Date: Jun. 26, 2003

(54) Speech recognition system and method

(75) Inventors: Paul St. John Brittan, Claverham (GB); Roger Cecil Ferry Tucker, Chepstow (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT PACKARD COMPANY

(21) Appl. No.: 10/322,623

(22) Filed: Dec. 19, 2002

(30) Foreign Application Priority Data
Dec. 20, 2001 (GB) 0130464.1

(51) Int. Cl. G10L 15/00

(52) U.S. Cl. 704/231

(57) ABSTRACT

A speech input stream is fed to a first speech recogniser. A confidence measure is formed for each recognition hypothesis produced in output by the first speech recogniser and this confidence measure is compared against an acceptability threshold. Where the confidence measure of a recognition hypothesis is below the threshold, the corresponding portion of the speech input is passed to a second speech recogniser and the recognition hypothesis produced is used instead of, or as a supplement to, that output by the first speech recogniser. In a preferred embodiment, the first speech recogniser is a recogniser trained to a particular user whilst the second recogniser is one associated with a particular speech application currently being accessed by the user.

### FIELD OF THE INVENTION

The present invention relates to a speech recognition system and method.

### BACKGROUND OF THE INVENTION

Speech recognition remains a difficult task to carry out with high accuracy for multiple users over a large vocabulary. Thus, the designer of a speech-based system often has to choose between a speech recognizer that can be trained by a specific user to recognize a wide vocabulary of words, and a speech recognizer that is capable of handling input from multiple users, without training, but only in respect of a more limited vocabulary. This choice is affected by whether the intended system is general purpose in nature requiring a large vocabulary or whether the system is only being designed for a specific application where generally a more limited vocabulary is sufficient. The choice can be complicated by other considerations such as available processing power. For example, whilst it is attractive to provide user-specific (user-trained) speech recognizers because of their potentially larger vocabulary and thus wider application, placing such recognizers in mobile equipment intended to be personal to the user is likely to limit the vocabulary that can be recognized because of the restricted processing and memory resources normally available to mobile personal equipment; in contrast, speech recognizers intended to take input from multiple users are usually associated with network applications where large processing resources are available.

Because a speech system is fundamentally trying to do what humans do very well, most improvements in speech systems have come about as a result of insights into how humans handle speech input and output. Humans have become very adapt at conveying information through the languages of speech and gesture. When listening to a conversation, humans are continuously building and refining mental models of the concepts being convey. These models are derived, not only from what is heard, but also, from how well the hearer thinks they have heard what was spoken. This distinction, between what and how well individuals have heard, is important. A measure of confidence in the ability to hear and distinguish between concepts, is critical to understanding and the construction of meaningful dialogue.

In automatic speech recognition, there are clues to the effectiveness of the recognition process. The closer competing recognition hypotheses are to one-another, the more likely there is confusion. Likewise, the further the test data is from the trained models, the more likely errors will arise. By extracting such observations during recognition, a separate classifier can be trained on correct hypotheses—such a system is described in the paper “Recognition Confidence Scoring for Use in Speech understanding Systems”, T J Hazen, T Buraniak, J Polifroni, and S Seneff, Proc. ISCA Tutorial and Research Workshop: ASR2000, Paris, France, September 2000. FIG. 1 of the accompanying drawings depicts the system described in the paper and shows how, during the recognition of a test utterance, a speech recognizer 10, supplied with a vocabulary and grammar 11, is arranged to generate a feature vector 15 that is passed to a separate classifier 16 where a confidence score (or a simply accept/reject decision) is generated. The downstream speech-system functionality (here represented by semantic understanding and action block 12) then uses the confidence classifier output in deriving the semantic meaning of the output from the speech recognizer 10.

It is an object of the present invention to provide improved speech recognition systems.

### SUMMARY OF THE INVENTION

According to one aspect of the present invention, there is provided a speech recognition method comprising the steps of:

(a) carrying out recognition of a speech input stream using a first speech recognizer to derive respective first recognition hypotheses for successive portions of the input stream;

(b) in carrying out step (a), determining a confidence measure for each first recognition hypothesis;

(c) at least in respect of those portions of the speech input stream for which the confidence measure is below an acceptability threshold, passing the speech input stream to a second speech recognizer to produce corresponding second recognition hypotheses; and

(d) forming an output recognition-hypothesis stream using recognition hypotheses from the first recognition hypotheses and only those second recognition hypotheses corresponding to the first recognition hypotheses that have a confidence measure below said threshold.

According to another aspect of the present invention, there is provided a speech recognition system comprising:

a first speech recognizer for carrying out recognition of a speech input stream to derive respective first recognition hypotheses for successive portions of the input stream;

an acceptability-determination subsystem for deriving a confidence measure for each first recognition hypothesis and comparing this measure with an acceptability threshold to determine the acceptability of the recognition hypothesis;

a second speech recognizer for producing second recognition hypotheses for portions of the input stream;

a transfer arrangement for passing to the second speech recognizer at least those portions of the speech input stream for which the confidence measure is below said acceptability threshold; and

a control arrangement for forming an output recognition-hypothesis stream using recognition hypotheses from the first recognition hypotheses and only those second recognition hypotheses corresponding to the first recognition hypotheses that have a confidence measure below said threshold.

### BRIEF DESCRIPTION OF THE DRAWINGS

Embodiments of the invention will now be described, by way of non-limiting example, with reference to the accompanying diagrammatic drawings, in which:

FIG. 1 is a diagram showing a known arrangement of a confidence classifier associated with a speech recognizer;

FIG. 2 is a diagram of a first system embodying the present invention; and

FIG. 3 is a diagram of a second system embodying the present invention.

### BEST MODE OF CARRYING OUT THE INVENTION

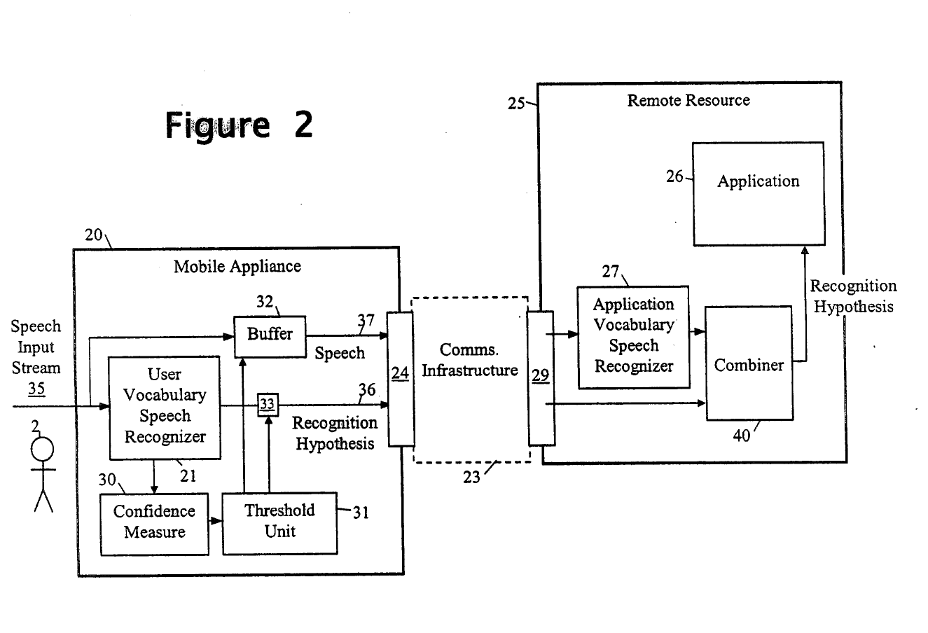

FIG. 2 shows a first embodiment of the present invention where a user 2 is using a mobile appliance 20 to interact with a speech application 26 hosted by a remote resource 25. The mobile appliance has a communications interface 24 for communicating speech and data signals over a communications infrastructure 23 with a corresponding communications interface 29 of the remote resource 25.

The form of the communications infrastructure 23 can take any form suitable for passing speech and data signals between the mobile appliance and remote resource 25. Thus, the communications infrastructure can comprise, for example, the public internet to which the resource 25 is connected, and a wireless network connected to the internet and communicating with the mobile appliance; in this case, the speech signals are passed as packetized data, at least over the internet. As another example, the communications infrastructure can simply comprise a voice network with the speech signals passed as voice signals and the data signals handled using modems.

The mobile appliance 20 has a first speech recogniser 21, this recogniser preferably being one which the user can train to recognise the user's normal vocabulary. A second speech recogniser 27 is provided as part of the remote resource 25, this recogniser preferably being intended for use by multiple users without training and having a vocabulary restricted to that needed for the speech application 26 or a related domain.

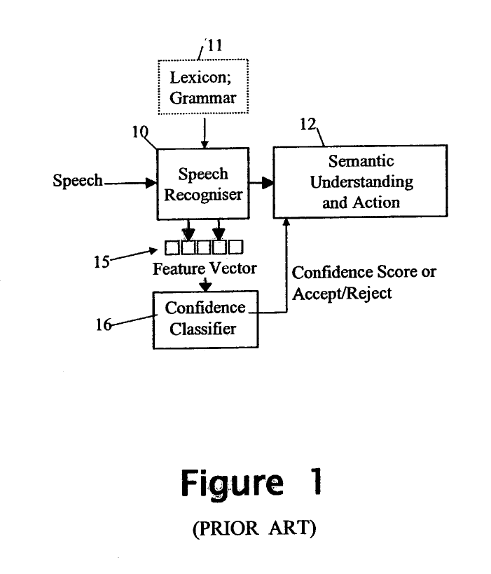

The first recogniser 21 produces a respective recognition hypothesis for each successive portion of the speech input stream 35 from user 2 (these speech portions can be individual phones, words or may be complete phrases). Associated with the first recogniser is a confidence-measure unit 30 that derives a confidence measure for each recognition hypothesis produced by the first recogniser; the unit 30 operates, for example, in a manner similar to that illustrated in FIG. 1 or in any other suitable manner. The confidence measure derived for each recognition hypothesis is then compared in threshold unit 31 to an acceptability threshold to determine whether the recognition hypothesis has reached an acceptable minimum confidence level. Where the recognition hypothesis produced by recogniser 21 has a confidence measure below the acceptability threshold, the corresponding speech portion that has been temporarily buffered in buffer 32, is passed (see arrow 37) via the communication interface 24, communications infrastructure 23, and communications interface 29 to the speech recogniser 27 of the remote resource 25 to produce a new recognition hypothesis for the speech portion concerned.

At least the acceptable recognition hypotheses produced by the mobile-appliance recogniser 21 (that is, those that are found to have acceptable confidence measures) are also passed (see arrow 36) to the remote resource 25.

At the remote resource 25, the recognition hypotheses received from the mobile appliance 20 are combined by a combiner 40 with the recognition hypotheses produced by the recogniser 27 in respect of those speech portions for which the mobile-appliance recogniser 21 failed to produce an acceptable recognition hypothesis. The nature of this combining carried out by combiner 40 can be simply the adding of the recognition hypotheses output by recogniser 27 into the stream of hypotheses output by recogniser 21 (in this case, all the recognition hypotheses produced by recogniser 21 are passed to the remote resource 25); alternatively, the hypotheses output by recogniser 27 can take the place of the corresponding hypotheses (the unacceptable hypotheses) output by recogniser 21 (in this case, the unacceptable hypotheses produced by recogniser 21 are preferably not passed to the remote resource but are cut out by a unit 33 controlled by threshold 31 as illustrated in FIG. 2—however, it is also possible to pass all the hypotheses from recogniser 21 to the remote resource and to use the combiner 40 to cut out the unacceptable ones on the basis of control data passed to it from threshold unit 31, this control data being indicative of the acceptability of each hypothesis from recogniser 21).

The output of the combiner 40 is a stream of recognition hypotheses that are passed to the speech application 26 for further processing and action (such action is likely to involve a response to the user 2 using an output channel not here illustrated or described). Where multiple recognition hypotheses are provided for the same speech portion, it is the responsibility of the application 26 to determine which hypothesis to accept (based, for example, on a high-level semantic understanding of the overall speech passage concerned); in this respect, it will be appreciated that, in practice, the application 26 maybe formed by multiple distinct functional elements that separate the interpretation of the recognition hypotheses from the core application logic.

The combiner 40 can be arranged to work simply on the basis of serialising the recognition hypotheses received on its two input on a first-in first-out basis; however, this runs the risk of a hypothesis produced by the recogniser 27 being included out of order (as judged relative to the order of the corresponding speech portions in the input speech stream) either because the recogniser 27 operates too slowly or because of delays in the communications infrastructure 23. It is therefore preferred to label each speech portion in the input stream with a sequence number which is also then used to label the corresponding recognition hypothesis; in this way, the combiner can correctly order the hypotheses it receives, buffering any hypotheses received out of order. In the case where the output recognition-hypothesis stream includes multiple hypotheses for the same speech input portion, the sequence numbers are preferably included in the output stream to enable the application 26 to recognise when such multiple hypotheses are present (other ways of indicating this are, of course possible).

In overall operation, the FIG. 2 embodiment operates to preferentially use the mobile-appliance speech recogniser 21 but to fall back to using the recogniser 27 at the remote resource when the mobile-appliance recogniser 21 produces a recognition hypothesis with an unacceptable confidence measure. By only passing speech signals to the remote resource in respect of the unacceptably recognised speech portions, where the speech signals are passed as packetized data over the communications infrastructure the loading of the latter is reduced as compared to passing all the speech data.

In a variant of the FIG. 2 embodiment, the recognition hypotheses generated by the remote-resource recogniser 27 can also have confidence measures produced for them. In this case, the unacceptable recognition hypotheses produced by the mobile-appliance recogniser 21 are also passed to the remote resource 25 together with their corresponding confidence measures. Where the combiner is arranged simply to include the output from the fallback recogniser 27 into the stream of hypotheses from recogniser 21, the confidence scores associated with each unacceptable hypothesis from recogniser 21 and the corresponding hypothesis from recogniser 27 are included in the output recognition-hypothesis stream from combiner 40 to facilitate the determination by application as to which application to use. However, where the combiner is arranged to substitute hypotheses from the fallback recogniser 27 for corresponding ones from the recogniser 21, the combiner 40 uses the confidence measures for corresponding hypotheses from the two recognisers to determine whether to accept a recognition hypothesis produced by the recogniser 27 or to use the corresponding hypothesis produced by the recogniser 21 (even though this latter hypothesis failed to reach the acceptability threshold). Of course, for the application 26 or combiner 40 to be able to make use of the confidence measures from the two recognisers, there needs to be a known relationship between the confidence measures produced for the two recognisers (preferably a direct correspondence); this relationship can be predetermined by carrying out comparative tests to calibrate the correspondence between the confidence measures.

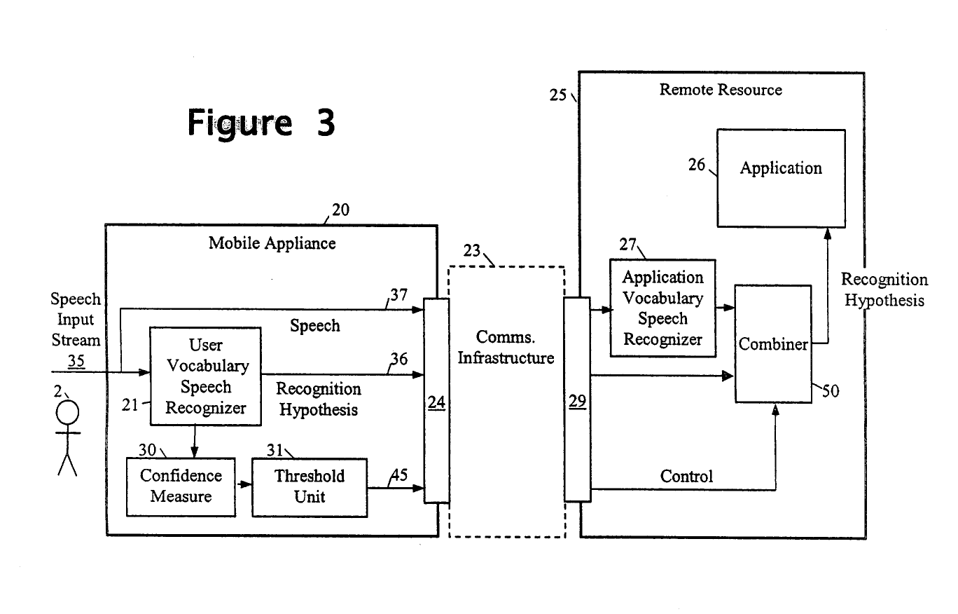

FIG. 3 shows a second embodiment of the present invention; this embodiment is similar to that of FIG. 2 in that a mobile appliance 20 is provided with a speech recogniser 21 with associated confidence measure unit 30 and threshold unit 31, and is arranged to interact, via communications infrastructure 23, with a speech application 26 hosted by a remote resource 25 that also hosts a second speech recogniser 27.

However, in the FIG. 3 embodiment all the speech input is passed not only to the mobile-appliance recogniser 21 but also to the remote-resource recogniser 27. In addition, all the recognition hypotheses produced by the recogniser 21 are passed to a combiner 50 to which the recognition hypotheses produced by the recogniser 27 are also passed. Combiner 50 further receives control data from the mobile appliance 20 in the form of acceptability data from the threshold unit 31 indicating whether the recognition hypotheses produced by the recogniser 21 have respective confidence measures that reach the acceptability threshold. The combiner 50 is arranged to replace or supplement the recognition hypotheses from the mobile-appliance recogniser that have unacceptable confidence measures, with the corresponding recognition hypotheses from the recogniser 27. As with the FIG. 2 embodiment, coordination data in the form of sequence labels are preferably used to identify the recognition hypotheses thereby to facilitate the operation of the combiner 50 in correctly sequencing the recognition hypotheses from the two recognisers.

Again, as discussed above in relation to the FIG. 2 embodiment, in a variant of the FIG. 3 embodiment the remote-resource recogniser 27 can have an associated confidence measure unit and the combiner 50 can be arranged either to include the confidence measures in the output recognition hypotheses stream (where the unacceptable hypotheses from recogniser 21 are being supplemented by hypotheses from fallback recogniser 27), or to use the confidence measures to only substitute a recognition hypothesis produced by the recogniser 27 for a corresponding below-acceptable hypothesis from the recogniser 21 where the hypothesis produced by recogniser 27 has a better confidence measure than that of the hypothesis produced by recogniser 21.

It will be appreciated that many other variants are possible to the above-described embodiments. For example, the equipment incorporating recogniser 21 need not be a mobile appliance and could, for example, be a desktop computer. Furthermore, the resource including the recogniser 27 can be close to the equipment including recogniser 21 being, for example, a server on the same LAN or a resource accessible over a short-range wireless link; indeed, the recognisers 21 and 27 could be in different items of mobile personal equipment (such as in a mobile phone and a PDA respectively) intercommunicating via a personal area network.

The speech application 26 need not be co-located with the recogniser 27 and the combiner can be located anywhere that is convenient including with the recogniser 21, with the recogniser 27 or with the application 26. Thus, for example, the recogniser 21 may be incorporated in a mobile phone along with a speech application whilst the fallback recogniser 27 is in a PDA carried by the same person as the mobile phone and communicating with the latter via a Bluetooth short-range radio link.

Multiple items of personal equipment each with a recogniser 21 can, of course, interact with the same fallback recogniser 27. Furthermore, multiple fallback recognisers can be provided in a parallel arrangement each arranged to receive the speech input passed on from mobile appliance 20 (or other item incorporating recogniser 21); in this case, the output of all the fallback recognisers are passed to the combiner which may choose the best recognition hypothesis (for example, based on coordinated confidence scores produced by confidence measure units associated with the fallback recognisers) or forward all hypotheses to the application.

It is also possible to provide a cascade of fallback recognisers. Thus, if the fallback recogniser 27 fails to produce a recognition hypothesis with an acceptable confidence score (as judged by a confidence measure unit associated with recogniser 27) for a speech portion unacceptably recognised by recogniser 21, then the recognition hypothesis output from a further recogniser can be taken into account for the speech portion concerned. Such a cascading of fallback recognisers can have any depth.

Each confidence measure produced by unit 30 can be a single parameter or can be made up of several parameters; in this latter case, judging whether the acceptability threshold has been met can be complicated as a good score for one parameter may be considered to compensate for a below-acceptable score in respect of another parameter. The threshold unit 31 can be programmed with appropriate rules for determining whether any particular combination of parameter values is sufficient to render the corresponding hypothesis as acceptable.

It will be appreciated that the functional blocks making up the mobile appliance 20 and remote resource 25 in FIGS. 2 and 3 will generally be implemented in program code run by a corresponding processor although, of course, equivalent hardware entities can be built.

1. A speech recognition method comprising the steps of:
(a) carrying out recognition of a speech input stream using a first speech recognizer to derive respective first recognition hypotheses for successive portions of the input stream;
(b) in carrying out step (a), determining a confidence measure for each first recognition hypothesis;
(c) at least in respect of those portions of the speech input stream for which the confidence measure is below an acceptability threshold, passing the speech input stream to a second speech recognizer to produce corresponding second recognition hypotheses; and
(d) forming an output recognition-hypothesis stream using recognition hypotheses from the first recognition hypotheses and only those second recognition hypotheses corresponding to the first recognition hypotheses that have a confidence measure below said threshold.

2. A method according to claim 1, wherein the output recognition-hypothesis stream comprises the first recognition hypotheses but with at least some of the hypotheses that have a confidence measure below said threshold replaced by the corresponding second hypotheses.

3. A method according to claim 1, wherein the output recognition-hypothesis stream comprises all said first recognition hypotheses and at least some of the second recognition hypotheses corresponding to the first recognition hypotheses that have a confidence measure below said threshold.

4. A method according to claim 1, wherein the first speech recognizer is local to a user and the second speech recognizer is remote from the user, step (c) involving passing speech input portions to the second speech recognizer over a communications infrastructure.

5. A method according to claim 4, wherein the second speech recognizer is part of a remote resource further including a speech application to which said output recognition-hypothesis stream is supplied, step (d) being carried out at the remote resource with at least the first recognition hypotheses that have corresponding confidence measures which reach said acceptability threshold, being passed to the remote resource.

6. A method according to claim 1, wherein the first and second speech recognizers are included in respective items of mobile personal equipment, step (c) involving passing speech input portions to the second speech recognizer over a short-range communications link.

7. A method according to claim 6, wherein the item of equipment including the first speech recognizer further includes a speech application to which said output recognition-hypothesis stream is supplied.

8. A method according to claim 1, comprising the further steps of:
(i) determining a confidence measure for each second recognition hypothesis;
(ii) at least in respect of those portions of the speech input stream for which the confidence measures of the corresponding second recognition hypotheses are below a second acceptability threshold, passing the speech input stream to a third speech recognizer to produce corresponding third recognition hypotheses;
the forming of the output recognition-hypothesis stream in step (d) using at least some of the third recognition hypotheses for which the corresponding first and second recognition hypotheses have associated confidence measures below their respective acceptability thresholds.

9. A method according to claim 1, wherein the first speech recognizer is trained to a user's voice and the second speech recognizer is intended to recognize a specific domain or application vocabulary spoken by different users without being training to their voices.

10. A method according to claim 1, wherein in step (c) only those portions of the speech input stream for which the corresponding first recognition hypotheses have confidence measures below the acceptability threshold are passed to the second speech recognizer.

11. A method according to claim 1, wherein in step (c) only those portions of the speech input stream for which the corresponding first recognition hypotheses have confidence measures below the acceptability threshold are passed to the second speech recognizer, and confidence measures are produced for the resultant second recognition hypotheses; step (d) involving including all the first and second recognition hypotheses in the output recognition-hypothesis stream together with confidence measures at least for the second recognition hypotheses and the corresponding first recognition hypotheses.

12. A method according to claim 1, wherein in step (c) only those portions of the speech input stream for which the corresponding first recognition hypotheses have confidence measures below the acceptability threshold are passed to the second speech recognizer, and confidence measures are produced for the resultant second recognition hypotheses; step (d) involving replacing a first recognition hypothesis with the corresponding second recognition hypothesis only when the confidence measures associated with the two hypotheses indicate at least a degree more confidence in the second recognition hypothesis as compared to the corresponding first recognition hypothesis.

13. A method according to claim 1, wherein in step (c) all portions of the speech input stream are passed to the second speech recognizer, and in step (d) all those first recognition hypotheses that have confidence measures below said acceptability threshold are replaced by the corresponding second hypotheses in the output recognition-hypothesis stream.

14. A method according to claim 1, wherein in step (c) all portions of the speech input stream are passed to the second speech recognizer and confidence measures are produced for the second recognition hypotheses, step (d) involving replacing a first recognition hypothesis with a corresponding second recognition hypothesis in the output recognition-hypothesis stream only when the confidence measures associated with the two hypotheses indicate at least a degree more confidence in the second recognition hypothesis as compared to the corresponding first recognition hypothesis.

15. A method according to claim 1, wherein in step (c) all portions of the speech input stream are passed to the second speech recognizer and confidence measures are produced for the second recognition hypotheses, step (d) involving including in the output recognition-hypothesis stream:
all the first recognition hypotheses,
the second recognition hypotheses for which the confidence measures of the corresponding first recognition hypotheses are below their acceptability threshold, and
the confidence measures at least for the included second recognition hypotheses and the corresponding first recognition hypotheses.

16. A speech recognition system comprising:
a first speech recognizer for carrying out recognition of a speech input stream to derive respective first recognition hypotheses for successive portions of the input stream;
an acceptability-determination subsystem for deriving a confidence measure for each first recognition hypothesis and comparing this measure with an acceptability threshold to determine the acceptability of the recognition hypothesis;
a second speech recognizer for producing second recognition hypotheses for portions of the input stream;
a transfer arrangement for passing to the second speech recognizer at least those portions of the speech input stream for which the confidence measure is below said acceptability threshold; and
a control arrangement for forming an output recognition-hypothesis stream using recognition hypotheses from the first recognition hypotheses and only those second recognition hypotheses corresponding to the first recognition hypotheses that have a confidence measure below said threshold.

17. A system according to claim 16, wherein the control arrangement is operative to form the output recognition-hypothesis stream by using the first recognition hypotheses but with at least some of the hypotheses that have a confidence measure below said threshold replaced by the corresponding second hypotheses.

18. A system according to claim 16, wherein the control arrangement is operative to form the output recognition-hypothesis stream by including all said first recognition hypotheses and at least some of the second recognition hypotheses corresponding to the first recognition hypotheses that have a confidence measure below said threshold.

19. A system according to claim 16, wherein the first speech recognizer is local to a user and the second speech recognizer is remote from the user, the transfer arrangement being operative to pass speech input portions to the second speech recognizer over a communications infrastructure.

20. A system according to claim 19, further comprising a remote resource comprising said second speech recognizer and a speech application to which said output recognition-hypothesis stream is supplied, the transfer arrangement being operative to pass to the remote speech-based resource at least the first recognition hypotheses that have corresponding confidence scores which reach said acceptability threshold, and the control arrangement comprising means for forming the output recognition-hypothesis stream at the remote resource.

21. A system according to claim 16, further comprising first and second items of personal mobile equipment respectively including said first and second recognizers, the said first and second items of equipment each further including a short-range communication subsystem by which speech input portions can be passed from the first to the second item of equipment.

22. A system according to claim 21, wherein the first item of equipment further includes a speech application, the control arrangement being operative to pass said output recognition-hypothesis stream to the speech application.

23. A system according to claim 16, wherein the first speech recognizer is trainable to a user's voice and the second speech recognizer is intended to recognize a specific domain or application vocabulary spoken by different users without being training to their voices.

24. A system according to claim 16, wherein the transfer arrangement is operative to pass to the second speech recognizer only those portions of the speech input stream for which the confidence measure is below the acceptability threshold.

25. A system according to claim 16, wherein the transfer arrangement is operative to pass to the second speech recognizer only those portions of the speech input stream for which the confidence measure is below the acceptability threshold, the system further comprising a further acceptability-determination subsystem for determining a confidence measure for each second recognition hypothesis, and the control arrangement being operative to form the output recognition-hypothesis stream by including all the first and second recognition hypotheses together with confidence measures at least for the second recognition hypotheses and the corresponding first recognition hypotheses.

26. A system according to claim 16, wherein the transfer arrangement is operative to pass to the second speech recognizer only those portions of the speech input stream for which the confidence measure is below the acceptability threshold, the system further comprising a further acceptability-determination subsystem for determining a confidence measure for each second recognition hypothesis, and the control arrangement being operative to form the output recognition-hypothesis stream by taking the first recognition hypotheses and replacing a first recognition hypothesis with the corresponding second recognition hypothesis only when the confidence measures associated with the two hypotheses indicate at least a degree more confidence in the second recognition hypothesis as compared to the corresponding first recognition hypothesis.

27. A system according to claim 16, wherein the transfer arrangement is operative to pass all portions of the speech input stream to the second speech recognizer, the control arrangement being operative to form the output recognition-hypothesis stream by replacing all those first recognition hypotheses that have confidence measures below said acceptability threshold by the corresponding second hypotheses.

28. A system according to claim 16, further comprising a further acceptability-determination subsystem for determining a confidence measure for each second recognition hypothesis, the transfer arrangement being operative to pass all portions of the speech input stream to the second speech recognizer, and the control arrangement being operative to form the output recognition-hypothesis stream by replacing a first recognition hypothesis with a corresponding second recognition hypothesis only when the confidence measures associated with the two hypotheses indicate at least a degree more confidence in the second recognition hypothesis as compared to the corresponding first recognition hypothesis.

29. A system according to claim 16, further comprising a further acceptability-determination subsystem for determining a confidence measure for each second recognition hypothesis, the transfer arrangement being operative to pass all portions of the speech input stream to the second speech recognizer, and the control arrangement being operative to form the output recognition-hypothesis stream by including:
all the first recognition hypotheses,
the second recognition hypotheses for which the confidence measures of the corresponding first recognition hypotheses are below their acceptability threshold, and
the confidence measures at least for the included second recognition hypotheses and the corresponding first recognition hypotheses.
